(19) United States
(12) Patent Application Publication
(10) Pub. No.: US 2008/0286644 A1
(43) Pub. Date: Nov. 20, 2008

(54) Label for secondary battery and secondary battery using the label

(76) Inventor: Kwangsoo Yeo, Yongin-si (KR)

Correspondence Address: ROBERT E. BUSHNELL, 1522 K STREET NW, SUITE 300, WASHINGTON, DC, 20005-1202, US

(21) Appl. No.: 12/000,179

(22) Filed: Dec. 10, 2007

(30) Foreign Application Priority Data
May 18, 2007 (KR) 10-2007-0048487

(51) Int. Cl. H01M 10/36; B32B 15/00

(52) U.S. Cl. 429/122; 428/457

(57) ABSTRACT

A label for a secondary battery has a multilayer structure so as to have different strength according to parts of the label and a secondary battery using the label. The label includes a main sheet surrounding at least a part of an outer surface of the battery and a reinforcing sheet stacked on a part of the main sheet to surround a part of the battery. The reinforcing sheet may be made of metal. The battery is formed in a rectangular shape and the reinforcing sheet surrounds at least a part of four relatively narrow side surfaces of the battery.

### CLAIM FOR PRIORITY

This application makes reference to, incorporates the same herein, and claims all benefits accruing under 35 U.S.C. §119 from an application for LABEL FOR SECONDARY BATTERY AND SECONDARY BATTERY USING THE SAME earlier filed in the Korean Intellectual Property Office on May 18, 2007 and there duly assigned Serial No. 2007-0048487.

### BACKGROUND OF THE INVENTION

1. Field of the Invention

The present invention relates to a label for a secondary battery and a secondary battery using the label, and more particularly, the present invention relates to a label that is formed with multilayer structure so as to have different strengths according to parts of the label and a secondary battery using the label.

2. Description of the Related Art

Generally, a secondary battery can be used repeatedly if it is charged, differently from a disposable battery which cannot be recharged. The secondary battery has been widely used in the fields of advanced small size electronic devices, such as cellular phones, PDAs, and notebook computers. More particularly, an operating voltage (i.e., 3.6 volts) of a lithium secondary battery is three times more than a Ni-Cd battery or a Ni-H battery, each of which has been frequently used as a power source for electronic devices and has high energy density per unit weight. Therefore, the use of lithium secondary batteries has been rapidly expanded.

A lithium secondary battery includes lithium oxides as a cathode active material and a carbonic material as an anode active material. Furthermore, the lithium secondary battery can be produced in many shapes, such as a cylindrical shape, an angular shape and a pouch shape.

For example, a pouch shaped lithium secondary battery is briefly explained below. The pouch shape secondary battery generally includes an electrode assembly and a pouch for receiving the electrode assembly so as to be sealed.

The electrode assembly includes an anode plate coating anode active material on a metal substrate, a cathode plate coating cathode active material on the base metal and a separator interposed between the anode plate and cathode plate. The separator is a solid film formed of polymer that insulates the cathode electrode plate from the anode electrode plate and moves lithium ions between the cathode plate and anode plate. Furthermore, electrode tabs are respectively attached to the cathode electrode plate and anode electrode plate.

The pouch includes a lower pouch film forming a receiving space of the electrode assembly and a upper pouch film having four side edges arranged along four side edges of the lower pouch film. The lower pouch film is formed so as to generally have receiving space inside thereof by a deep drawing process and the four side edges of the upper and lower pouch films are attached to each other generally by thermal bonding. Furthermore, in the cathode plate and anode plate of the electrode assembly, the electrode tab has one end extending out of the pouch. The extended part of the pouch is insulated by an insulation tape.

However, because the pouch of the conventional pouch shaped secondary battery is relatively weak mechanically, a bare cell including the electrode assembly and the pouch may be easily deformed by an external force. In other words, the external shape of the pouch shaped bare cell cannot be molded into a particular shape. More particularly, the pouch shaped bare cell usually has a rectangular structure and accordingly, even if a relatively narrow side surface of the bare cell is formed in a bent shape, the narrow side surface of the bent shape is easily deformed due to the pressure caused by an external force.

Accordingly, the narrow side surface of the bare cell is formed to have irregular shape. A battery pack is formed by covering the narrow side surface of the pouch shaped bare cell with a separate frame. This enables the capacity of the pouch shaped secondary battery to become relatively small in comparison with the total size thereof. In other words, the narrow side surface of the pouch shaped bare cell is formed in a bent shape by the relatively thick frame, and thus, the total size of the pouch shaped secondary battery is increased. Furthermore, a relatively wide remaining space may exist between the irregular narrow side surface and the frame, thereby causing a useless volume increase in comparison with the capacity of the battery.

In the conventional pouch shaped secondary battery, because the electrode tab of the electrode assembly is extended out of the pouch, the surface of the pouch becomes non-uniform due to the thickness of the electrode tab. In other words, the electrode tab of the electrode assembly is extended through a part of bonding part between the upper and lower pouch films and thus, the surface of the pouch sealed by bonding the upper and lower pouch films is irregularly formed at the extended part of the electrode tab.

This causes a relatively wide remnant space between the irregular surface of the pouch shaped bare cell and a metal plate and a label, when the pouch shaped bare cell is manufactured in a battery pack by covering relatively wide front and back surfaces with the metal (usually stainless) plate and wrapping with the label. Accordingly, the capacity of the pouch shaped secondary battery becomes small in comparison with total size of the secondary battery.

Furthermore, because the battery pack of the conventional pouch shaped secondary battery includes the frame, the metal plate and the label, the manufacturing process is complicated and the manufacturing cost becomes relatively high.

### SUMMARY OF THE INVENTION

Accordingly, an object of the present invention is to provide a label and a secondary battery using the label that can maintain a bent shape while a side surface of a pouch shaped secondary battery does not increase its total size.

Another object of the present invention is to provide a label and a secondary battery using the label that can prevent or reduce surface projection phenomenon caused by an electrode tab of a pouch shaped secondary battery.

Still another object of the present invention is to provide a label and a secondary battery using the label that can simplify manufacturing processes of a pouch shaped bare cell in the form of a pack and reduce the manufacturing cost.

Additional advantages, objects and features of the present invention is set forth in part in the description which follows and in part will become apparent to those having ordinary skill in the art upon examination of the following or may be learned from the practice of the present invention.

According to one aspect of the present invention, a label for a secondary battery is provided, the label including: a main sheet surrounding at least a part of an outer surface of a battery; and a reinforcing sheet stacked on a part of the main sheet to surround a part of the battery.

The reinforcing sheet may be formed of material having a higher strength than that of the main sheet.

The reinforcing sheet may be formed of metal.

The reinforcing sheet may be formed of a thin aluminum plate to be thermally bonded to the main sheet.

The battery may be rectangular, and the reinforcing sheet may surround at least a part of four relatively narrow side surfaces of six surfaces of the battery. The reinforcing sheet may be formed of a pair of reinforcing sheets to surround two relatively long side surfaces of the four side surfaces of the battery and a space between the pair of reinforcing sheets may be less than a length of a relatively short side surface.

The main sheet may form the label for the battery.

The label may further include a finishing sheet stacked on one surface of the main sheet on which the reinforcing sheet has been stacked, while covering the reinforcing sheet. The finishing sheet may be the same size as the main sheet. Furthermore, the finishing sheet may form the label for the battery.

According to another aspect of the present invention, a secondary battery is provided, the secondary battery including: a pouch shaped cell including a relatively narrow side surface and relatively wide upper and lower surfaces respectively arranged at upper and lower parts of the side surface; and a label including a relatively large main sheet having a relatively low strength and a first relatively small reinforcing sheet having a relatively high strength, where the main sheet and the first reinforcing sheet are stacked together, the main sheet surrounds at least a part of the side surface and the upper and lower surfaces of the pouch shaped cell, and the first reinforcing sheet surrounds at least a part of the side surface of the pouch shaped cell.

The pouch shaped cell may include an electrode tab extending outside the battery and the first reinforcing sheet of the label may have the same thickness as that of the electrode tab.

The pouch shaped cell may be rectangular, and the first reinforcing sheet of the label may surround a relatively long side surface of four narrow side surfaces of the pouch shaped cell.

The label may further include a second reinforcing sheet that surrounds a relatively short side surface of the four narrow side surfaces of the pouch shaped cell and is made of material having a higher strength than that of the main sheet. The second reinforcing sheet maybe formed of metal. Furthermore, the second reinforcing sheet may be formed of a thin aluminum plate thermally bonded to the main sheet.

The second reinforcing sheet may have the same size as the relatively short side surface of the pouch shaped cell and horizontally surround the relatively short side surface of the pouch shaped cell.

The label may further include a finishing sheet stacked on one surface of the main sheet on which the reinforcing sheet has been stacked, while covering the first reinforcing sheet.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a plan view of a label for a secondary battery according to one exemplary embodiment of the present invention;

FIG. 2 is a sectional view taken along II-II line of FIG. 2;

FIG. 3 is a perspective view of the label of FIG. 1 being applied to a pouch shaped secondary battery;

FIG. 4 is a side view of FIG. 3;

FIG. 5 is a sectional view of a pouch shaped secondary battery to which the label has been applied according to FIGS. 3 and 4;

FIG. 6 is a sectional view of a label for a secondary battery according to another embodiment of the present invention;

FIG. 7 is a plan view of a label for a secondary battery according to still another embodiment of the present invention;

FIG. 8 is a sectional view taken along VIII-VIII line of FIG. 7;

FIG. 9 is a perspective view of the label of FIG. 7 being applied to a pouch shaped secondary battery; and

FIG. 10 is a sectional view of a pouch shaped secondary battery to which the label of FIG. 9 has been applied.

### DETAILED DESCRIPTION OF THE INVENTION

Hereinafter, exemplary embodiments of the present invention are described in detail with reference to the accompanying drawings. The aspects and features of the present invention and methods for achieving the aspects and features will be apparent by referring to the embodiments described in detail with reference to the accompanying drawings. However, the present invention is not limited to the embodiments disclosed hereinafter, but can be implemented in diverse forms. The matters defined in the description, such as the detailed construction and elements, are merely specific details provided to assist those of ordinary skill in the art in a comprehensive understanding of the present invention, and the present invention is only defined within the scope of the appended claims. In the entire description of the present invention, the same drawing reference numerals are used for the same elements across various figures.

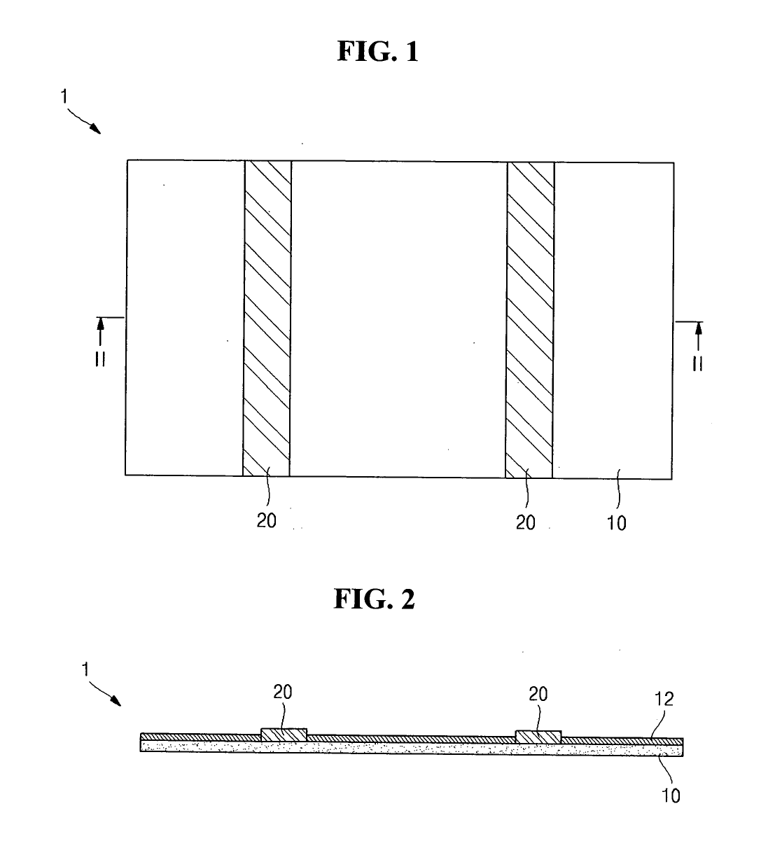

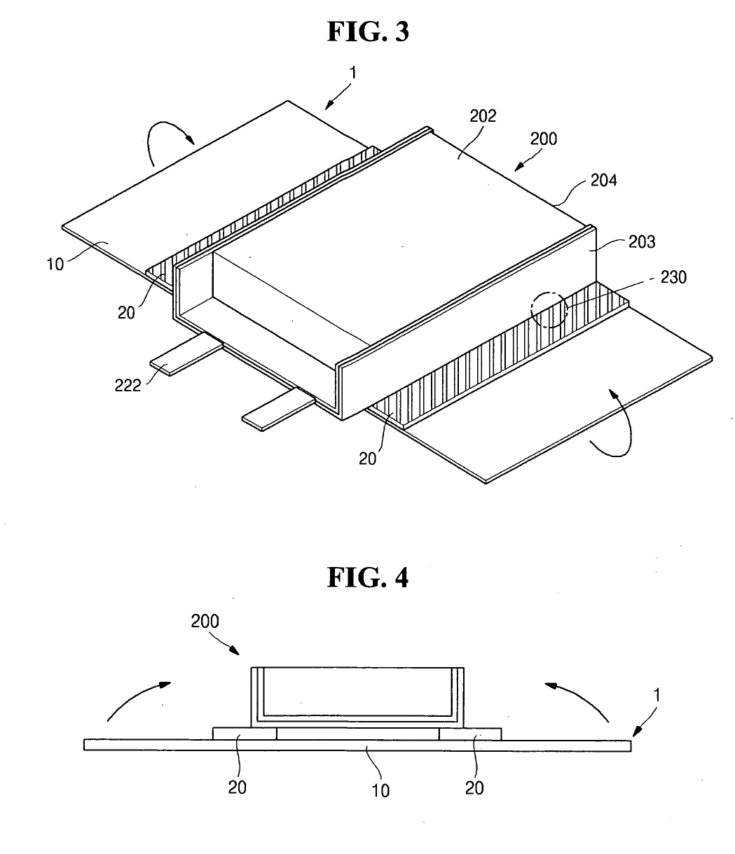

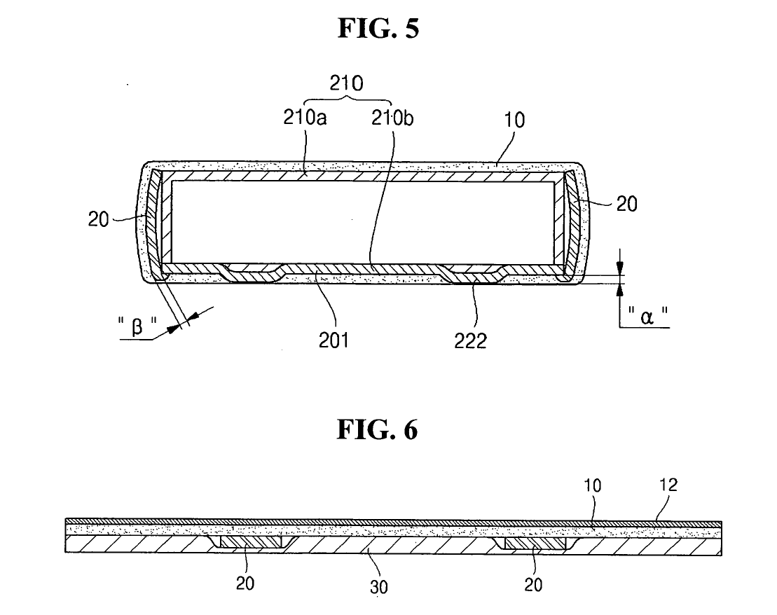

FIG. 1 is a plan view of a label for a secondary battery according to one exemplary embodiment of the present invention and FIG. 2 is a sectional view taken along II-II line of FIG. 2. FIG. 3 is a perspective view of the label of FIG. 1 being applied to a pouch shaped secondary battery and FIG. 4 is a side view of FIG. 3 and FIG. 5 is a sectional view of a pouch shaped secondary battery to which the label has been applied according to FIGS. 3 and 4.

Referring to FIGS. 1 and 2, a label 1 for a secondary battery includes a main sheet 10 and a reinforcing sheet 20.

The main sheet 10 is formed to surround the entire battery or a portion of the battery. An adhesive layer 12 is formed on one surface of the main sheet 10. The main sheet 10 may be attached to an outer surface of the battery via the adhesive layer 12.

The reinforcing sheet 20 is stacked on a part region of the main sheet 10 so as to surround a part of the battery. Because the reinforcing sheet 20 is stacked on the part region of the main sheet 10, the part of the label 1 for a secondary battery including the reinforcing sheet 20 has strength higher than the other part based on total size of the main sheet 10. Furthermore, the reinforcing sheet 20 is preferably formed of material having a higher strength than the main sheet 10 so as to protect the battery by surrounding a part of the battery and be arranged on the outer surface of the battery to maintain a certain shape.

The reinforcing sheet 20 may be metal having excellent strength and workability. For example, the reinforcing sheet 20 may be a thin aluminum plate attached to one surface of the main sheet 10. Furthermore, the main sheet 10 may be a label on which a rated voltage or a manufactured date is written.

The battery may have a rectangular or roughly rectangular shape and the reinforcing sheet 20 may surround a part of four side surfaces of the rectangular battery.

Referring to FIGS. 3 to 5, the battery is a rectangular or roughly rectangular pouch shaped cell 200. In other words, an outer shape of the pouch shaped cell 200 has four relatively narrow side surfaces 203 and 204 and two relatively wide surfaces 201 and 202 facing each other, among the four side surfaces 203 and 204. The two relatively wide surfaces 201 and 202 are referred to as an upper surface and a lower surface respectively. A surface where an electrode tab 222 of an electrode assembly has been arranged is referred to as the lower surface 201. The four relatively narrow side surfaces 203 and 204 include two relatively long side surfaces 203 facing each other and two relatively short side surfaces 204 facing each other. The two relatively long side surfaces 203 are referred to as a first side surface and the two relatively short side surfaces 204 are referred to as a second side surface.

The main sheet 10 is attached to the whole or a part of the lower surface 201, the upper surface 202 and the first side surface 203. The main sheet 10 is attached to the outer surface of the pouch shaped cell 200 via the adhesive layer 12 formed on one surface of the main sheet as described above. In the embodiment, the shape that the main sheet 10 surrounds a remaining outer surface of the entire outer surfaces of the pouch shaped cell 200 except for a part where the electrode tab 222 has been extended and a second side surface 203 opposite to the electrode tab 222 is described as one example. However, the present invention is not limited thereto. That is, the main sheet 10 may surround the outer surface of the pouch shaped cell 200 more widely or more narrowly.

The reinforcing sheet 20 is stacked on one surface having the adhesive layer of the main sheet 10 so as to surround the first side surface 203 of the pouch shaped cell 200. Because the reinforcing sheet 20 is formed of metal, such as a thin aluminum plate, it maintains a certain shape without deformation caused by external forces while being arranged on the first side surface 203.

The reinforcing sheet 20 may be arranged on the first side surface 203 of the pouch shaped cell 200 in a bent shape.

Referring to FIGS. 4 and 5, the pouch shaped cell 200 is arranged on one surface having the adhesive layer 12 of the main sheet 10 and parts of right and left ends of the pouch shaped cell 200 are placed on one surface of the reinforcing sheet 20. In other words, a distance between two reinforcing sheets is greater than a length of the second side surface of the pouch shaped cell. When the main sheet 10 is folded in the direction of the arrows of FIG. 4, the reinforcing sheet 20 with its part pressed on both ends of the pouch shaped cell 200 is bent in a bent shape of small curvature so as to be arranged on the first side surface 203 of the pouch shaped cell 200. Since a folded leading edge is attached to the upper surface 202 of the pouch shaped cell 200, the reinforcing sheet 10 maintains the bent shape.

Referring to FIG. 5, one end of the reinforcing sheet 20 may aligned on the same line as the corner toward the upper surface 202 of the pouch shaped cell 200 and the other end may contact the front surface 203 of the pouch shaped cell 200 beyond the corner toward the lower surface 201 of the pouch shaped cell 200. The thickness of the reinforcing sheet 20 may be the same as that of the electrode tab 222 of the pouch shaped cell 200. In FIG. 5, “β” indicates a thickness of the reinforcing sheet 20 and “α” indicates a height of a projected part formed on the lower surface 201 of the pouch shaped cell 200. A value of “β” is the same as that of “α”. In other words, the reinforcing sheet 20 arranged on the left and right ends compensate for the height difference between the projected surface of a pouch 210 projected by the electrode tab 222 and other surfaces. Accordingly, the main sheet 10 attached on the lower surface 201 of the pouch shaped cell 200 may be a plane or roughly plane shape.

Upper and lower pouch films 210a and 210b form the pouch 210.

According to the construction as described above, the first side surface 203 of the pouch shaped cell 200 is formed in the bent shape. Because first side surface 203 of the bent shape is made of metal having strength, it is not deformed by external forces and maintains its original shape. The relatively thin reinforcing sheet 20 having high strength is arranged on the first side surface 203 in the bent shape, thereby allowing an increase in the thickness of the side surface according to the packing of the pouch shaped cell 200 to be minimized. In other words, the reinforcing sheet 20 forming a part of the label 1 for a secondary battery is arranged on the side surface of the pouch shaped cell 200 so as to function as a frame. Because the reinforcing sheet 20 is arranged simultaneously with a process of attaching the main sheet 10 to the pouch shaped cell 200, the packing of the pouch shaped cell 200 is simplified. When the main sheet 10 of the label 1 for a secondary battery is formed of a label, the pouch shaped cell 200 has the shape of a battery pack according to the work of attaching the label.

As described above, the part projected by the electrode tab 222 at the lower surface 201 of the pouch shaped cell 200 is compensated for by the thickness of the reinforcing sheet 20, thereby allowing the main sheet 10 to be attached to the lower surface 201 of the pouch shaped cell 200 in a plane or roughly plane shape.

On the other hand, FIG. 6 is a view of a label for a secondary battery according to another embodiment of the present invention.

Referring to the FIG. 6, the label 1 for a secondary battery includes a main sheet 10, a reinforcing sheet 20 and a finishing sheet 30.

The main sheet 10 and the reinforcing sheet 20 are similar to those of the embodiment of FIGS. 1 to 5, except that the reinforcing sheet 20 is arranged on a surface opposite to a surface where an adhesive layer 12 of the main sheet 10 has been formed. Furthermore, the finishing sheet 30 is attached to the main sheet 10 so as to cover the reinforcing sheet 10. The finishing sheet 30 is preferably of the same size as the main sheet 10. The finishing sheet 30 forms the label for the secondary battery.

According to the construction as described above, the entire surface of the main sheet 10 can be attached to an outer surface of the pouch shaped cell 200. As a result, the bond between the label and the pouch shaped cell 200 can be stronger. Because the main sheet 10 and the finishing sheet 30 are very thin, the total size of the pouch shaped cell 200 is not changed even if one more finishing sheet 30 is added to the pouch shaped cell 200.

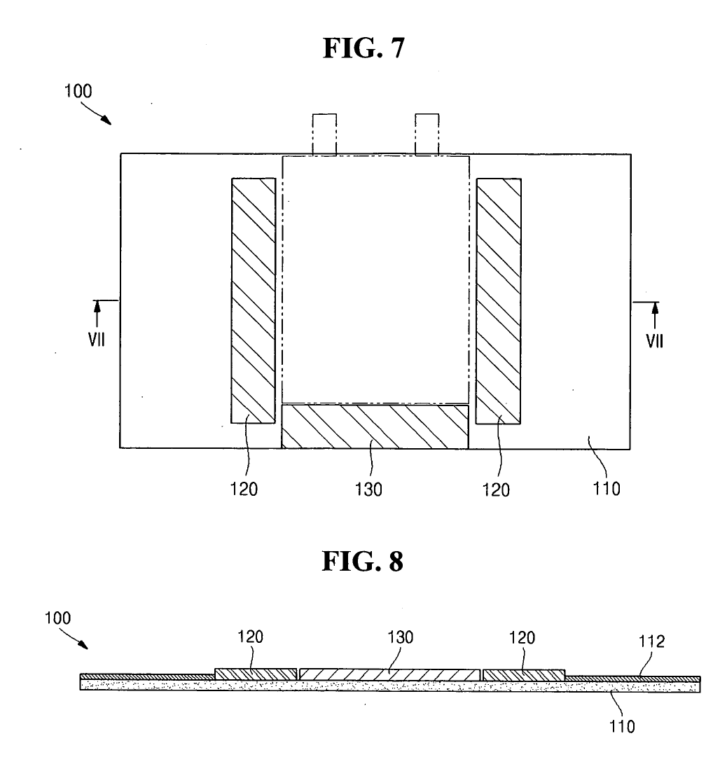

FIGS. 7 to 10 are views of a label for a secondary battery according to still another embodiment of the present invention and a pouch shaped secondary battery to which the label has been applied. In the embodiment of FIGS. 1 to 5, it has been explained as an example that the reinforcing sheet of the label surrounds only the first side surface of the pouch shaped cell. However, in the present embodiment, a reinforcing sheet of the label surrounds both first and second side surfaces of a pouch shaped cell.

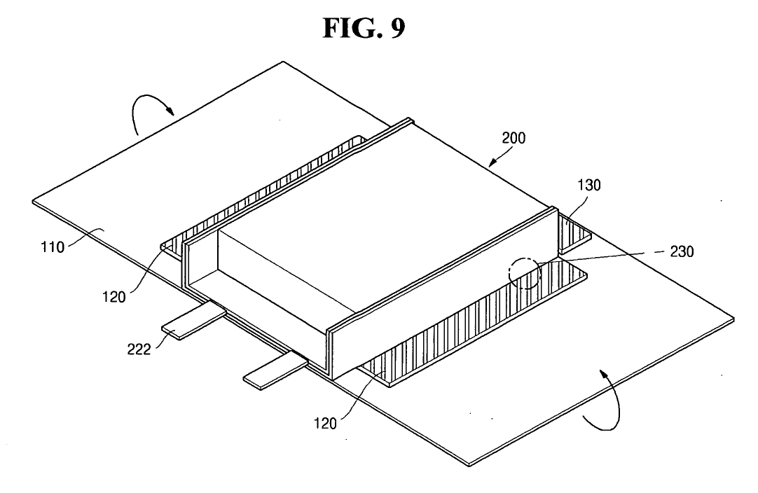

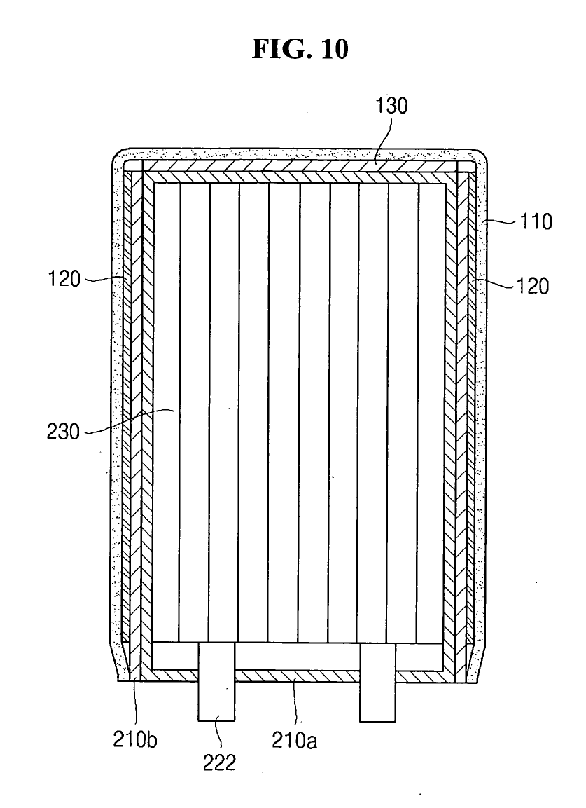

FIG. 7 is a plan view of the label for a secondary battery according to still another embodiment of the present invention and FIG. 8 is a sectional view taken along VIII-VIII line of FIG. 7. FIG. 9 is a perspective view of the label of FIG. 7 being applied to the pouch shaped secondary battery and FIG. 10 is a sectional view of the pouch shaped secondary battery to which the label has been applied according to FIG. 9.

Referring to FIGS. 7 and 8, the label for a secondary battery 100 includes a main sheet 110, a first reinforcing sheet 120 and a second reinforcing sheet 130. The pouch shaped cell 200 of the embodiment has the same construction as the embodiment of FIGS. 1 to 5. Accordingly, the same drawing reference numerals are used for the same elements.

The main sheet 110 is of a size that can surround upper and lower surfaces 201 and 202 and a first side surface 203 of a pouch shaped cell 200. The main sheet 110 may include an adhesive layer 112 formed on its one surface and may be attached to an outer surface of the pouch shaped cell 200 via the adhesive layer 112. The main sheet 110 may be a label on which a rated voltage or a manufactured date is written.

The first reinforcing sheet 120 is stacked on the main sheet 110 so as to surround the first side surface 203 of the pouch shaped cell 200, and the second reinforcing sheet 130 is stacked on the main sheet 110 so as to surround the second side surface 204 of the pouch shaped cell 200 opposite to an electrode tab 222. The first and second reinforcing sheets 120 and 130 are formed of thin aluminum plates so as to be thermally bonded to the main sheet 110. The first reinforcing sheet 120 may be arranged on the first side surface 203 of the pouch shaped cell 200. Because the first reinforcing sheet 120 is arranged on the first side surface 203 of the pouch shaped cell 200 in a bent shape is the same as the reinforcing sheet 10 being arranged on the first side surface 203 of the pouch shaped cell 200 in a bent shape in the embodiment of FIGS. 1 to 5, a detailed explanation thereof has been omitted.

Furthermore, the second reinforcing sheet 130 has the same size as the second side surface 204 of the pouch shaped cell 200 surrounded by the second reinforcing sheet 130. The reinforcing sheet 130 may surround the second side surface 204 of the pouch shaped cell 200 while contacting the second side surface 204 horizontally. In an arrangement similar to the first reinforcing sheet 120, the second reinforcing sheet 130 is attached to the second side surface 204 of the pouch shaped cell 200 by attaching the main sheet 110 to an outer surface of the pouch shaped cell 200.

According to the construction as described above, which is similar to the embodiment of FIGS. 1 to 5, the first side surface 203 of the pouch shaped cell 200 is formed in a bent shape and the second side surface 204 is surrounded by the second reinforcing sheet 130 made of metal so as to be protected. As a result thereof, since the relatively thin first and second reinforcing sheets 120 and 130 having a high strength are arranged on the side surface of the pouch shaped cell 200, the pouch shaped cell 200 can be packed almost without an increase in thickness of the side surface. The pouch shaped cell 200 is packed simultaneously with process of attaching the label to the pouch shaped cell 200. In other words, the packing of the pouch shaped cell 200 is simplified.

The label for the secondary battery 100 according to the present embodiment may further include a finishing sheet similar to the embodiment of FIG. 6. Accordingly, a detailed explanation thereof has been omitted.

As described above, the label and secondary battery using the label according to the present invention produce the following effects.

First, according to the label for a secondary battery and the secondary battery using the label, the side surface of the pouch shaped secondary battery can maintain the bent shape without an increase in total size.

Second, the surface projecting phenomenon of the pouch shaped secondary battery can be prevented or reduced. Accordingly, the pouch shaped bare cell can be easily manufactured in the form of a pack and the manufacturing cost can be reduced.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as being limitations of the present invention.

What is claimed is:

1. A label for a secondary battery, the label comprising:
a main sheet surrounding at least a part of an outer surface of the battery; and
a reinforcing sheet stacked in a part of the main sheet to surround a part of the battery.

2. The label for a secondary battery of claim 1, wherein the reinforcing sheet comprises a material having a higher strength than that of the main sheet.

3. The label for a secondary battery of claim 1, wherein the reinforcing sheet comprises a thin aluminum plate thermally bonded to the main sheet.

4. The label for a secondary battery of claim 1, wherein the reinforcing sheet comprises a metal.

5. The label for a secondary battery of claim 1, wherein the battery is rectangular and has six surfaces, and wherein the reinforcing sheet surrounds at least a part of four relatively narrow side surfaces of the six surfaces of the battery.

6. The label for a secondary battery of claim 5, wherein the reinforcing sheet comprises a pair of sheets arranged to surround two relatively long side surfaces of the four relatively narrow side surfaces of the battery.

7. The label for a secondary battery of claim 6, wherein a distance between the pair of sheets is less than a length of a relatively short side surface of the battery.

8. The label for a secondary battery of claim 1, wherein the main sheet comprises a label for the battery.

9. The label for a secondary battery of claim 1, further comprising:
a finishing sheet stacked on one surface of the main sheet on which the reinforcing sheet has been stacked, the finishing sheet being arranged to cover the reinforcing sheet.

10. The label for a secondary battery of claim 9, wherein the finishing sheet comprises a label for the battery.

11. The label for a secondary battery of claim 9, wherein a size of the finishing sheet is the same as that of the main sheet.

12. A secondary battery comprising:
a pouch shaped cell including a relatively narrow side surface and relatively wide upper and lower surfaces respectively arranged at upper and lower parts of the side surface; and
a label including a relatively large main sheet having a relatively low strength and a first relatively small reinforcing sheet having a relatively high strength, wherein the main sheet and the first reinforcing sheet are stacked together, the main sheet surrounding at least a part of the side surface and the upper and lower surfaces of the pouch shaped cell, and the first reinforcing sheet surrounding at least a part of the side surface of the pouch shaped cell.

13. The secondary battery of claim 12, wherein the pouch shaped cell comprises an electrode tab extending outside the battery and wherein the first reinforcing sheet of the label has a same thickness as that of the electrode tab.

14. The secondary battery of claim 12, wherein the pouch shaped cell is rectangular, and wherein the first reinforcing sheet of the label surrounds two relatively long side surfaces of four relatively narrow side surfaces of the pouch shaped cell.

15. The secondary battery of claim 14, wherein the label comprises a second reinforcing sheet surrounding a relatively short side surface of the four narrow side surfaces of the pouch shaped cell and wherein the second reinforcing sheet comprises a material having a higher strength than that of the main sheet.

16. The secondary battery of claim 15, wherein the second reinforcing sheet comprises a metal.

17. The secondary battery of claim 15, wherein the second reinforcing sheet comprises a thin aluminum plate thermally bonded to the main sheet.

18. The secondary battery of claim 15, wherein the second reinforcing sheet has a same size as that of the relatively short side surface of the pouch shaped cell and wherein the second reinforcing sheet horizontally surrounds the relatively short side surface of the pouch shaped cell.

19. The secondary battery of claim 12, wherein the label comprises a finishing sheet stacked on one surface of the main sheet on which the reinforcing sheet has been stacked, the finishing sheet covering the first reinforcing sheet.
